(19) United States
(12) Patent Application Publication
(10) Pub. No.: US 2002/0099550 A1
(43) Pub. Date: Jul. 25, 2002

(54) Alarm clock variable by an external data source

(76) Inventor: John J. Emerick JR., Addison, TX (US)

Correspondence Address: FRANK C. NICHOLAS, CARDINAL LAW GROUP, Suite 2000, 1603 Orrington Ave., Evanston, IL, 60201, US

(21) Appl. No.: 09/765,843

(22) Filed: Jan. 19, 2001

(51) Int. Cl. G10L 21/00

(52) U.S. Cl. 704/270

(57) ABSTRACT

An alarm clock with a variable alarm sound based on information provided by an external data source receives and processes a data file from an external source that contains information related to the alarm sound to be played upon activation of the alarm. When the alarm is triggered, the programmable controller accesses stored control programs, and plays audio content from sources available to it as described by the control programs. The received data file contains information that modifies the control programs of the microprocessor and affects the manner in which the alarm playback is conducted. A preferred embodiment is capable of receiving both programming instructions and data files from an Internet connection, and includes integrated sources of audio playback, a floppy data drive, a video display, and the capability of sending signals to an Internet web site.

### BACKGROUND OF THE INVENTION

This invention relates generally to the field of signal processing, and more particularly to an alarm clock for downloading programming instructions and audio content transmitted from an external source for use in playback of customized sounds when the alarm state is activated.

Alarm clocks have been known to the art for many years. They allow a user to be awakened by either an alarm or the sound of a radio, and more recently, to the sound of an audio CD. The user may choose from a limited number of options about what sounds are played when the alarm is triggered. The user has the ability to pre-select which type of sound is played, and sometimes has the option of first playing one type of sound, then playing another type of sound after a predetermined time period. An example of such an application is the playing of a radio station for ten minutes, after which time an alarm sound is played. The user can pre-select the radio station or CD that is to be played. In the case of a radio station, the user may preselect a radio station that plays mainly a certain type of audio content, such as a light jazz radio station, but has a limited ability to synchronize the alarm with the beginning of any specific programming content. For example, in the case of tuning to a light jazz radio station, the user is often awakened to the sound of a local commercial rather than the sound of light jazz music. In addition, radio reception is limited to geographically local stations.

Communications devices that receive, decode, store, and playback audio data files are also known to the art. In many applications, audio sound files are downloaded from an Internet connection, and the sound files are played on a personal computer and its related sound system. Such uses are not widely used today; primarily due to the large size of such data files and the current maximum download speed of modems. In typical applications, the sound files are downloaded upon user request, in which case as the data is downloading, the first portion of audio material is cached in memory, and is then played while successive portions of the audio material are downloaded. Thus, the downloading and playback occur nearly simultaneously, and playback in continuous even if the download process has some degree of discontinuity. This process reduces the amount of time a user must wait before hearing the audio content. Video content is handled similarly. In most applications, computer users who wish to download audio content use their personal computer to connect to a web site and to request the information based on available options listed on the web site.

In the prior art, alarm clocks have been designed with a variety of user settings and preprogrammed settings that provide variety to the type of sounds being played. In one feature, the volume of the alarm increases as time increases. Snooze buttons allow the user to temporarily silence the alarm for a predetermined time period. Some alarm clocks limit the total time that the alarm will be played to a specific period, such as one hour, to prevent the alarm from sounding continuously if the user is unable to halt the alarm. Typical clock radios offer the user the choice of either waking to an alarm sound, waking to the radio, or waking to the radio for a predetermined time period followed by an alarm sound. Volume buttons are usually provided that may or may not adjust the volume of the alarm, but typically adjust the volume of the radio or CD.

An application of an alarm clock receiving data from an external source in order to offer a variety in alarm sounds is described in U.S. Pat. No. 5,832,067. In that patent, the alarm clock has a user setting that determines which type of alarm sound to play from a given selection on the alarm clock. When the alarm state is activated, the alarm clock then sends a request to a server by means of a telephone line requesting that sound file. The alarm clock and the server form an integrally related system, in which the intelligence of the system is incorporated into the alarm clock, and the server acts essentially as a slave data source. When the alarm is activated, the alarm clock sends a request to the server based upon the setting of the switch on the alarm clock device.

One application of an alarm clock receiving operational data from an external source is described in patent U.S. Pat. No. 5,991,240, where a broadcast signal is received and the time of day is pulled from that signal in order to reset the time on the alarm clock. That patent is specifically related to the setting of time.

Despite the addition of the features previously described, the prior art in alarm clocks does not offer a great deal of flexibility in the qualitative experience of how a user is awakened. The alarm sound itself is predefined in quality, and only adjustable in volume. Radio content is limited to local radio in real time mode. CD content is limited to the particular CD loaded in the unit. The sequencing of different sounds is limited to one or two choices, and predominantly predefined in aspects of sequence and length of time for playback. Volume adjustments for each sequence of sounds are predefined, usually fixed by the position of the volume knob. Thus, the radio volume and the alarm volume are generally not independently controlled.

The prior art related to U.S. Pat. No. 5,832,067 attempts to address some of these limitations. This invention describes an alarm clock that contacts a server for a predetermined file based upon user settings on the alarm clock. The alarm clock and the server are operatively coupled, whereas the intelligence of the system originates in the alarm clock apparatus, and the server acts as a slave data device. The flexibility of this system is limited by the degree to which the alarm clock operating parameters are defined, and by the degree to which user input can be made through manual adjustments on the alarm clock apparatus. Additionally, the alarm clock apparatus is responsible for initiating communication with the server based upon its generating an alarm signal, and therefore must be capable of initiating contact with the server, which limits the flexibility in using different servers or different means of connecting to such servers. This system also describes a real time system, in which the audio message is downloaded in response to the alarm signal. Operationally, this does not address how to compensate for variables such as the size of the audio file, speed of download, and status of the device-server connection, which can significantly affect the reliability and timeliness of the alarm. Further, the functionality of this system is defined by the design and programming of the alarm clock apparatus; thus many future changes in user features would not be available to older models, and the alarm clocks are vulnerable to becoming outdated with each new or modified feature. Finally, the data connection is limited to that of a telephone line.

Despite the added flexibility of this type of system, there is still a great deal of customization and flexibility that is lacking, as will be described herein.

The prior art does not disclose a device that receives an unsolicited data file from an external source. Additionally, the prior art does not disclose a device that receives a data file from an external source that adjusts the operational settings of the alarm clock in a similar fashion as user settings that are typically integral to the alarm clock device. Further, the prior art does not disclose a device that receives instructions for how to combine, sequentially or otherwise, audio sources from a variety of sources, including internally generated sounds, downloaded sound files, and sounds from connected peripheral devices, in a manner that is defined by an outside data source.

### SUMMARY OF THE INVENTION

The primary object of the invention is to provide an alarm clock in which the alarm sounds can be varied based on information provided by an external data source.

Another object of the invention is to provide an alarm clock, in which the programming instructions for user preferences are received and downloaded from an external source, stored in memory, and made available for use based on user settings on the device itself.

Another object of the invention is to provide an alarm clock in which alarm sounds can be updated or changed on a regular basis, such as with a subscription-based service.

Another object of the invention is to provide an alarm clock in which audio files are received and downloaded from an external source, stored in memory, and made available for playback.

A further object of the invention is to provide an alarm clock in which connections to the external source of data may be discontinuous such that information is uploaded and downloaded in batch mode at a time that is independent of the time at which the alarm state is activated.

A further object of the invention is to provide an alarm clock in which the playback of multiple audio files and audio sources is orchestrated based on programming instructions received from an external source, such that features including time intervals, snooze features, volumes, and other relevant variables for each alarm sound can be varied based upon a combination of the data received by the invention and device control settings on the alarm clock unit.

Yet another object of the invention is to provide an alarm clock in which video images can be used in the same manner as alarm sounds.

Still yet another object of the invention is to provide an alarm clock that can be networked to another device, such as a home computer, which can expand the functionality of the alarm clock device and allow it to work in conjunction with one or more of external sources of memory, audio playback devices, an external DSP, and sound system equipment.

These and other objects, features, and advantages are accomplished by an alarm clock in which the alarm sound can be varied based on data received from an external data source. The alarm clock comprises a means of connection to an external data source; a digital signal processor for receiving data from an external source, a programmable controller for processing data from the external source and for processing programming instructions, memory for storing programming instructions and audio files and a connection for connecting to a speaker.

In accordance with a preferred embodiment of the present invention, the alarm clock further includes one or more of an audio playback device capable of providing audio sounds as requested by the programming, device controls for varying user settings from the alarm clock device, a video display for displaying video images, and a display for displaying information regarding the programming settings.

In accordance with another preferred embodiment of the present invention, a connection is provided for connecting to peripheral devices that can supplement the functionality of the alarm clock device, including one or more of; a connection for an external digital signal processor; a connection for an external memory source; a connection for an external audio playback device; a connection for an external data drive; a connection for an external network connecting device.

The present invention is intended to be an alarm clock apparatus that can be designed and operated as a relatively simple device with only a minimum of user inputs, and relies on the data from the external source for providing much of the flexibility and customization desired by the user. In one embodiment, a web site is provided with software that allows a user to enter the site, and select from a very large variety of choices in audio content files, sequences of playback for multiple files, volume at each point in the playback, time intervals devoted to each playback file, sources of audio for each segment of the entire playback, times available for download, file sizes, estimated times to download, forwarding or reversing instructions when the user hits a user setting such as a snooze button, and so forth. This complexity is handled by the web site, which then constructs the audio files and contacts the alarm clock apparatus for download. The intelligence of this system lies outside the hardware and software of the alarm clock apparatus, thus enabling this alarm clock device to be simple in construction and design. The device is less prone to becoming outdated, since many new or modified user features would be incorporated into the web site software and would not require a hardware upgrade. The download process is coordinated by the web site, and may take place days or hours prior to the actual alarm, thus ensuring that the sound files are available when the alarm is activated, and avoiding potential problems in the download due to intermittent server connections.

The present invention is a far simpler alarm clock apparatus than that described in U.S. Pat. No. 5,832,067. The alarm clock apparatus is not required to initiate a connection with a server, and it does not require a great deal of user interface or manual adjustments. The alarm clock apparatus does not need to download data files in real time, and thus does not need to account for the variables involved with size of the file, speed of download, and the status of the connection. In addition, the alarm clock apparatus does not require a switch defining user-selectable states. The means of connection to the external data source does not necessarily involve a telephone line, since it could be connected by any of a variety of means that allow data transmission between peripheral devices.

In such a system, it is envisioned that the web site can provide a tremendous variety of audio files for download, unrestricted to geographic locale, and the user can precisely define the timing of the download. Alternative embodiments of the present invention offer even greater levels of user customization and flexibility in hardware and connection requirements. In one embodiment, video files are also displayed by the invention, which could offer the user near real time images of things like current, local weather or current, local traffic situations. The present invention, when working in conjunction with such a data source, could provide a level of flexibility and customization far greater than anything described in the prior art.

Other objects and advantages of the present invention will become apparent from the following descriptions, taken in connection with the accompanying drawings, wherein, by way of illustration and example, embodiments of the present invention are disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a block diagram in accordance with a preferred embodiment of the present invention;

FIG. 2 is a block diagram of an alternate embodiment of the present invention;

FIG. 3 is a block diagram of another alternate embodiment of the present invention;

FIG. 4 is a block diagram of another alternate embodiment of the present invention; and

FIG. 5 is a diagram of another embodiment of the present invention.

### DETAILED DESCRIPTION OF THE PREFERRED EMBODIMENTS

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

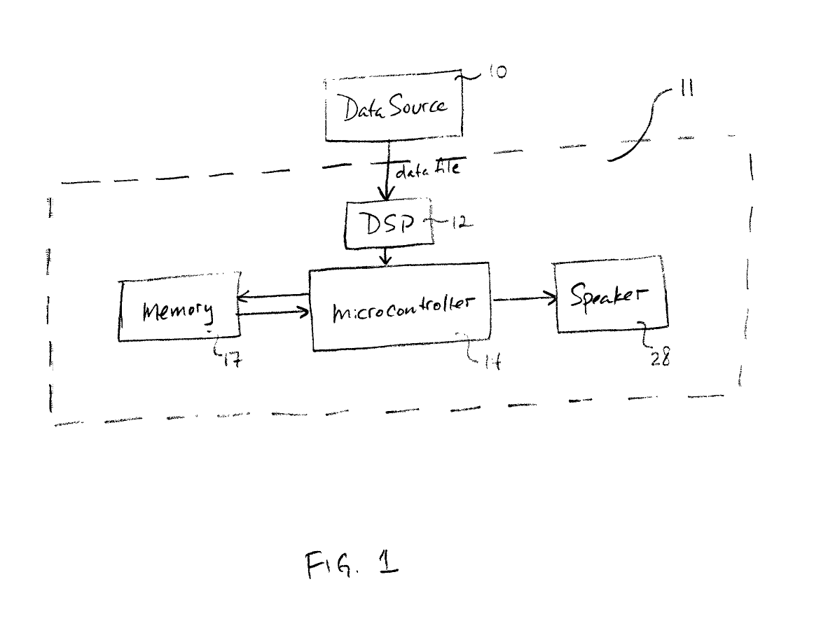

FIG. 1 shows a block diagram of alarm clock 11 in accordance with an illustrated embodiment of the present invention. Alarm clock device 11 is connected to external data source 10 for receiving data from that source; examples of this source could be an Internet site, a locally networked home computer, a locally networked data device, or a remote device on an independent computer network. Digital signal processor 12 receives and processes digital signals. Digital signal processor 12 is connected to microprocessor or microcontroller 14 for controlling the overall operation of alarm clock 11, including memory 17 and speaker 28. The memory 17 stores audio data files and control programs executable by microprocessor 14. Speaker 28 plays the alarm sound under control of microprocessor 14.

In operation, digital signal processor 12 receives data from external data source 10 in the form of control programs and audio data files. The data is processed by digital signal processor 12, sent to microcontroller 14, and stored in memory 17. These control programs provide information to microcontroller 14 that affect the manner of playback of the alarm sound. These control programs provide instructions in one or more of the following: which audio files to access when the alarm state is activated, how long to access them, in which sequence to access them, the sources from which the audio content is obtained, the manner in which audio files are downloaded, the volume characterization of the audio content, and other variables. If control program information is not received from the data source, microprocessor 14 will function according to prior instructions and default information as determined by its programming.

In addition, digital signal processor 12 receives audio data files from external source 10, sends them to microcontroller 14, and stores them in memory 17 in a manner consistent with its programming instructions. These audio data files are available for playback to the microcontroller as needed to fulfill its programming instructions. If no audio data files are received, then microprocessor 14 will function according to prior instructions and default information as determined by its programming.

Memory 17 is used in accordance with the programming instructions provided by the microcontroller 14. Caching of the audio files may be used for simultaneous download and playback of audio data files.

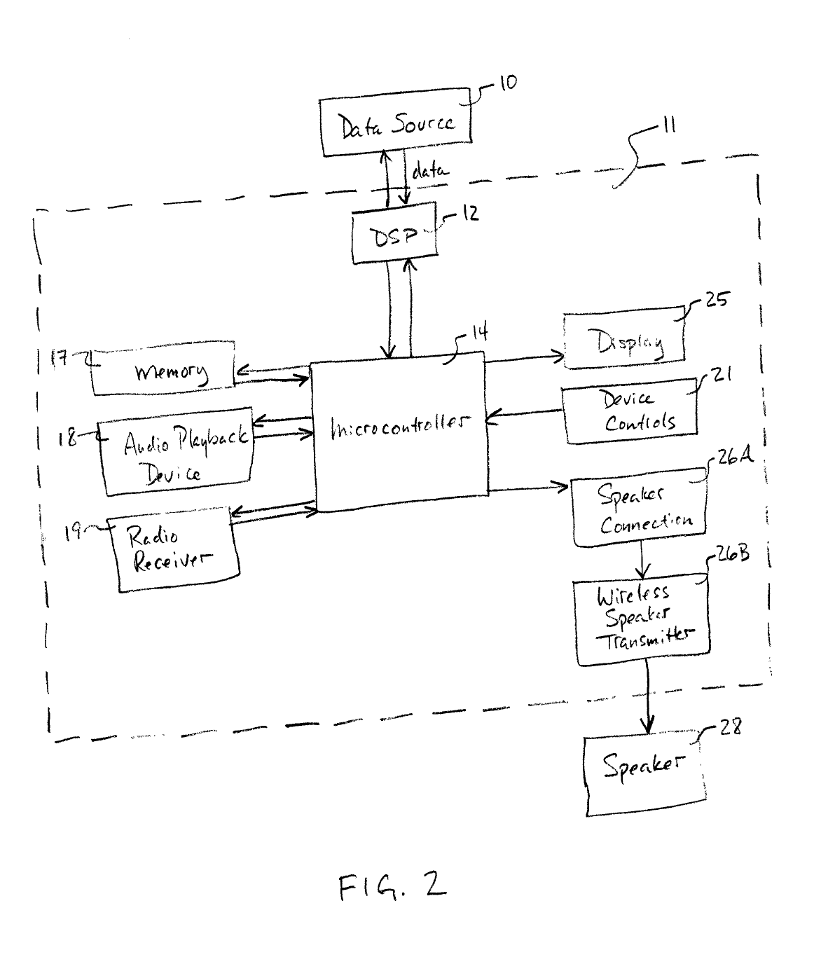

FIG. 2 shows a block diagram of a more extensive depiction of alarm clock 11 in an alternate embodiment. In accordance with additional aspects of the present invention, microcontroller 14 sends a signal to digital signal processor 12, which processes and sends the data to data source 10. Data source 10 sends information to the digital signal processor 12, which processes and sends the data to the microcontroller 14. Using these means of communication, information is transmitted in one or both directions between data source 10 and microcontroller 14, allowing the microcontroller 14 to request information as required by its control programs and interactive communication to proceed between microcontroller 14 and data source 10. Device controls 21 are provided to allow the user to affect the control programs of microcontroller 14. Display 25 provides a means of displaying information to the user regarding the status of the control programs. In another aspect of the invention, display 25 provides a means of displaying video content as instructed by microcontroller 14. Speaker connection 26A is connected to microcontroller 14 to receive audio output signals from microcontroller 14 and sends them to wireless speaker broadcast unit 26B. In this way, device 11 can be connected by wireless communication means to speaker 28 that is external to alarm clock device 11.

In accordance with additional aspects of the present invention, microcontroller 14 is connected to audio playback device 18 and radio receiver 19. In operation, the microcontroller determines if audio content is required from these sources, and when required, the audio content will be retrieved from these sources and sent to speaker connection 26.

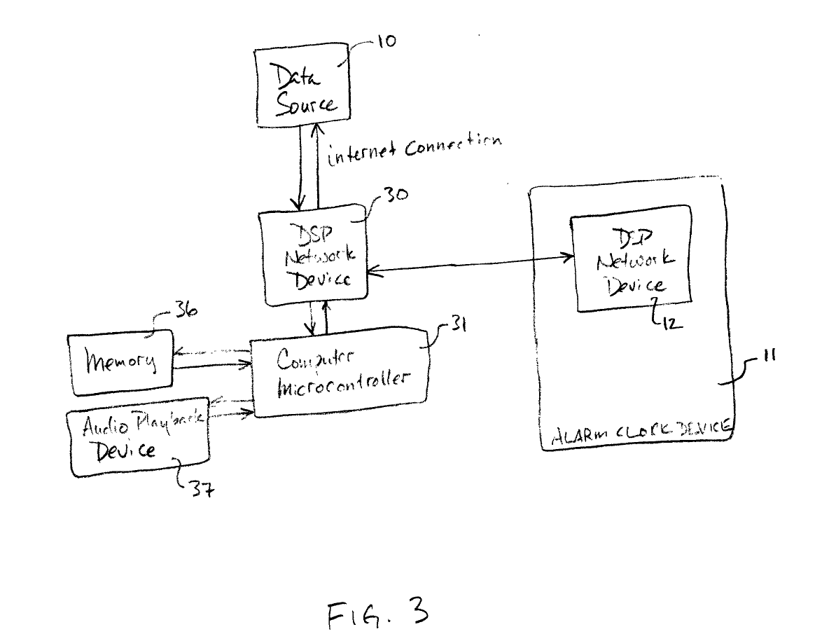

FIG. 3 shows a block diagram of a third depiction of alarm clock device 11. In operation, alarm clock device 11 is connected to a network device 30. This connection allows device 11 access to information from data source 10. In addition, this connection allows device 11 to have a connection to external computer microcontroller 31, and a sequential connection to external memory 36 and audio playback device 37. Thus, alarm clock device 11 is able to use the resources of peripheral equipment 10, 30, 31, 36 and 37 on the network to fulfill its programming instructions.

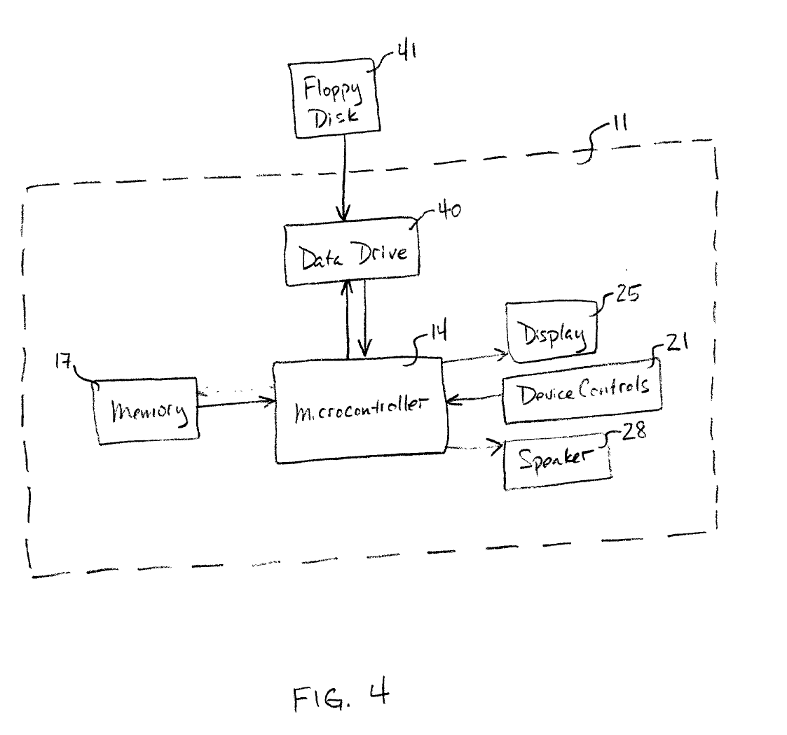

FIG. 4 shows a block diagram of a fourth depiction of alarm clock device 11. In operation, data drive 40 is capable of receiving data from data disk 41, and sends that information to microcontroller 14 for processing.

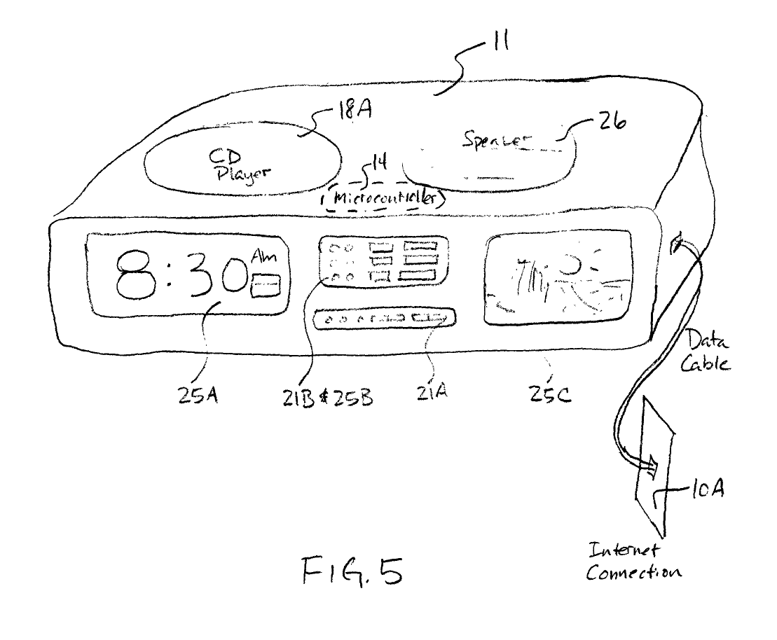

FIG. 5 shows a sketch of one embodiment of the present invention. Alarm clock device 11 is comprised of displays 25A, 25B and 25C, which show the time, the status of programming instructions, and video content respectively. Further, device controls 21A and 21B, which enable the end user to manually provide input to microcontroller 14, speaker 26 for playing sound outputs, a connection via a data cable to an external data source on the internet 10A; and an audio CD playback device 18A are included. In operation, the device 11 receives data from Internet connection 10A in the form of control program information and audio data files and video data files. Audio and video files are stored in memory. The user provides input to microprocessor 14 via device controls 21A and 21B including the time at which to activate an alarm sound. When an alarm state is activated by microcontroller 14, the audio files are played in accordance with the current program instructions, and audio CD playback device 18A is activated according to current program instructions. Upon activation of the alarm state, the user may elect to input information to microcontroller 14 by means of device controls 21A and 21B. In such a manner, the user can activate control programs for snooze features commonly understood in the prior art, and can activate other features such as advancing to the next audio file, volume changes, extending playback times of any audio files, repeat or continuous playback of audio files, and deactivation of the alarm state.

Having described specific preferred embodiments of the invention with reference to the accompanying drawings, it is to be understood that the invention is not limited to those precise embodiments and that various changes and modifications may be effected therein by one skilled in the art without departing from the scope or the spirit of the invention as defined in the appended claims.

1. An alarm clock in communication with an external source of at least one audio data file, the alarm clock comprising:
a digital signal processor for receiving a data signal from the external source and for decoding the received data signal to obtain the audio data file;
a memory for storing the audio data file;
a programmable controller for coordinating the transfer of the audio data file from the digital signal processor to the memory, and for activating an alarm sound coded in the audio data file when the programmable controller determines that the alarm sound is required to fulfill the programming instructions of the programmable controller; and
a speaker for playing the alarm sound.

2. An alarm clock as claimed in claim 1 further comprising a display for displaying information received from the programmable controller regarding the programming instructions.

3. An alarm clock as claimed in claim 1 further comprising at least one manual input control that is used to provide an input of information to the programmable controller to supplement the programming instructions of the programmable controller.

4. An alarm clock as claimed in claim 1 further comprising an audio playback device wherein the device can be accessed by the programmable controller as an alternate source of an audio data file for use in the programmable controller fulfilling the programming instructions.

5. An alarm clock as claimed in claim 4 wherein the audio playback device is at least one of a cassette tape player, a CD-ROM player, a radio, a computer disk drive, a video cassette player, and a video digital drive.

6. An alarm as claimed in claim 1 further comprising:
a video display;
a memory for storing a video data file; and
a programmable controller for displaying the encoded video image on the display when the programmable controller determines that the display of the video image is required to fulfill the programming instructions.

7. An alarm clock as claimed in claim 6 further comprising:
a means of connection to an external source of at least one video data file;
a digital signal processor for receiving a data signal from the external source, and for decoding the received signal to obtain the video data file; and
a programmable controller for coordinating the transfer of the video data file from the digital signal processor to the memory.

8. An alarm clock as claimed in claim 1 wherein the memory can be used to store at least two data files that are one of audio and video.

9. An alarm clock as claimed in claim 1 wherein the alarm clock is connected to the external source of at least one audio data file by a digital signal processor receiving signals from at least one of an internet connection, a local computer network connection, an independent data drive, an independent audio playback device, and an independent computer.

10. An alarm clock as claimed in claim 1 wherein the memory for storing the audio data file is located separate from the physical alarm clock unit and is accessed by the alarm clock by a data connection.

11. An alarm clock as claimed in claim 1 wherein the memory performs as a buffering memory.

12. An alarm clock as claimed in claim 10 wherein the data connection connects the alarm clock to at least one of an external computer, an external data storage device, an external computer drive unit, a computer server that is part of a local computer network, and a computer server that is part of the world wide web internet.

13. An alarm clock as claimed in claim 1 wherein the speaker for playing the alarm sound is connected to the alarm clock by one of a direct, wired connection to a speaker, a wireless radio connection to a speaker, a wireless infrared connection to a speaker, and a means of transmitting data to a speaker that includes transmitting data in a wireless manner.

14. An alarm clock as claimed in claim 1 wherein the digital signal processor decodes the received signal to obtain a set of transmitted programming instructions that are used to supplement the programming instructions of the programmable controller.

15. An alarm clock as claimed in claim 14 wherein the received signal is received from one of an Internet connection, a local computer network connection, an independent data drive, an independent audio playback device, and an independent computer.

16. An alarm clock as claimed in claim 14 wherein the programmable controller sends a data signal to the digital signal processor, and the digital signal processor transmits a signal to an external receiving device.

17. An alarm clock as claimed in claim 1 wherein the time and date on the alarm clock is synchronized with the time and date on the external data source.
